(19) United States
(12) Patent Application Publication
(10) Pub. No.: US 2019/0289142 A1
(43) Pub. Date: Sep. 19, 2019

(54) INFORMATION COLLECTING APPARATUS AND NON-TRANSITORY COMPUTER READABLE MEDIUM STORING PROGRAM

(71) Applicant: FUJI XEROX CO., LTD., TOKYO (JP)

(72) Inventor: Yoshihiro TAKESHITA, Kanagawa (JP)

(73) Assignee: FUJI XEROX CO., LTD., TOKYO (JP)

(21) Appl. No.: 16/292,357

(22) Filed: Mar. 5, 2019

(30) Foreign Application Priority Data
Mar. 15, 2018 (JP) 2018-048301

(51) Int. Cl. H04N 1/00; H04L 29/08

(52) U.S. Cl. CPC H04N 1/00323; H04L 67/1008; H04L 67/12; H04N 1/00206

(57) ABSTRACT

An information collecting apparatus includes an acquiring unit that acquires, from an information processing apparatus, pieces of device information indicating pieces of information acquirable by the information processing apparatus from network devices, an information identifying unit that identifies information necessary for an analysis to be executed by an analysis unit among the pieces of device information, and a transmitting unit that transmits, to the information processing apparatus, an instruction to collect the information identified by the information identifying unit among the pieces of information acquirable by the information processing apparatus from the network devices but not to collect information other than the identified information.

### CROSS-REFERENCE TO RELATED APPLICATIONS

This application is based on and claims priority under 35 USC 119 from Japanese Patent Application No. 2018-048301 filed Mar. 15, 2018.

### BACKGROUND

### (i) Technical Field

The present disclosure relates to an information collecting apparatus and a non-transitory computer readable medium storing a program.

### (ii) Related Art

In recent years, there has been remarkable development of Internet of Things (IoT) in which devices of any types are connected to the Internet to exchange information. When a predetermined application is installed in a computer, IoT devices may be used via the computer. The IoT devices include a wide variety of devices such as various sensors and household appliances. Analyses are executed by acquiring various types of information from the IoT devices distributed in a predetermined area. Analysis results may be used for various services such as proposals for improvement related to effective use of the area and arrangement of the IoT devices. An apparatus that collects information from the IoT devices may collect information directly or via an information processing apparatus.

Japanese Unexamined Patent Application Publication No. 2017-102627 and Japanese Unexamined Patent Application Publication (Translation of PCT Application) No. 2016-528610 are examples of related art.

### SUMMARY

Aspects of non-limiting embodiments of the present disclosure relate to reduction of a load of information collection executed by an information collecting apparatus compared with a case of collecting all information sent from network devices.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information collecting apparatus comprising an acquiring unit that acquires, from an information processing apparatus, pieces of device information indicating pieces of information acquirable by the information processing apparatus from network devices, an information identifying unit that identifies information necessary for an analysis to be executed by an analysis unit among the pieces of device information, and a transmitting unit that transmits, to the information processing apparatus, an instruction to collect the information identified by the information identifying unit among the pieces of information acquirable by the information processing apparatus from the network devices but not to collect information other than the identified information.

### BRIEF DESCRIPTION OF THE DRAWINGS

An exemplary embodiment of the present disclosure will be described in detail based on the following figures, wherein:

FIG. 1 is a conceptual diagram illustrating the overall configuration of a network system of an exemplary embodiment;

FIG. 2 is a hardware configuration diagram of an edge server of the exemplary embodiment;

FIG. 3 is a block configuration diagram of the edge server of the exemplary embodiment;

FIG. 4 illustrates an example of the data structure of IoT device information stored in an IoT device information storing part of the exemplary embodiment;

FIG. 5 illustrates an example of the data structure of device identification information to be transmitted from a multifunction peripheral to the edge server in the exemplary embodiment; and

FIG. 6 is a flowchart illustrating processing to be executed by the edge server when pieces of device identification information are transmitted from the multifunction peripheral in the exemplary embodiment.

### DETAILED DESCRIPTION

An exemplary embodiment of the present disclosure is described below with reference to the drawings.

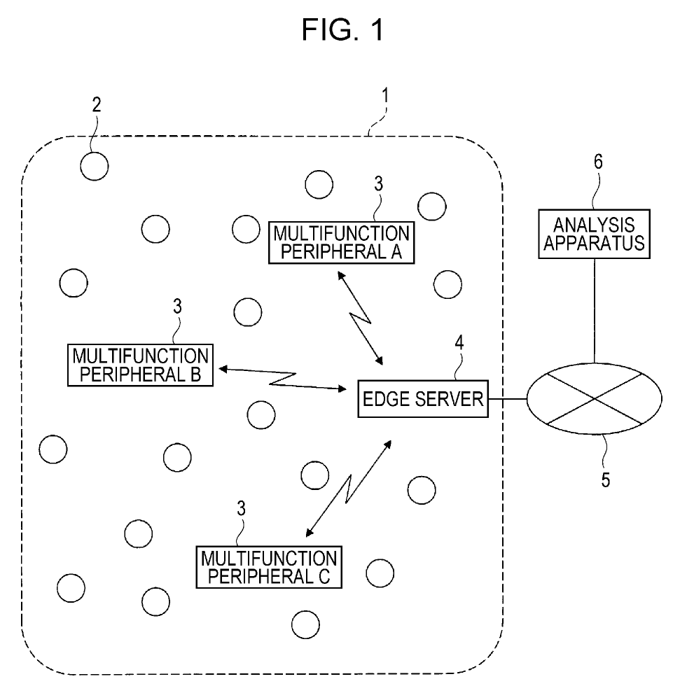

FIG. 1 is a conceptual diagram illustrating the overall configuration of a network system of this exemplary embodiment. FIG. 1 illustrates IoT devices 2, multifunction peripherals 3, and an edge server 4 that are installed in a certain area 1, and an analysis apparatus 6 connected to the edge server 4 via a network 5. The area 1 is a facility such as a building.

The “IoT device” refers to anything connected to the Internet. In general, the IoT device refers to a thing other than IT devices such as a PC and a smartphone. The IoT device herein refers broadly and collectively to any device connected to the Internet to exchange information. Examples of the IoT device include various sensing devices (for example, a temperature sensor, a humidity sensor, a voltage sensor, a current sensor, and a sound sensor), display devices such as a projector and a liquid crystal display, recording devices, reproduction devices, imaging devices such as a camera, watches and clocks, surveillance cameras, unmanned aerial vehicles (so-called drone), and game machines. Examples of the IoT device may also include household appliances such as a refrigerator, a rice cooker, a microwave oven, a coffee maker, a vacuum cleaner, a washing machine, an air conditioner, and a lighting device. The IoT device 2 of this exemplary embodiment sends information to the multifunction peripheral 3 or the edge server 4 by wire or wireless via a network (not illustrated) in the area 1. Examples of a communication standard (scheme) include Wi-Fi (registered trademark) communication, infrared communication, visible light communication, and close proximity wireless communication (for example, near field communication (NFC)). Examples of the close proximity wireless communication to be used include Felica (registered trademark), Bluetooth (registered trademark), and a radio frequency identifier (RFID).

The multifunction peripheral 3 is an image forming apparatus having an image forming function (at least one function out of a scanning function, a printing function, a copying function, and a facsimile function). The multifunction peripheral 3 of this exemplary embodiment also functions as an information processing apparatus having a function of data communication with the IoT devices 2. As illustrated in FIG. 1, the plurality of multifunction peripherals 3 are distributed in the area 1. The multifunction peripheral 3 acquires information sent from an IoT device 2 (hereinafter referred to as “IoT information”) specified by the edge server 4 out of detected IoT devices 2 and transmits the acquired IoT information to the edge server 4. For example, when the IoT device 2 is a certain type of sensor, sensor data including a sensor value detected by the sensor corresponds to the IoT information.

FIG. 1 is a plan view of the area 1. When the area 1 is a building having a plurality of floors, the IoT devices 2 and the multifunction peripherals 3 are distributed on the respective floors. The multifunction peripheral 3 executes data communication with IoT devices 2 arranged nearby (IoT devices 2 located within a communicable range).

The edge server 4 is a server computer provided in the area 1 as an information collecting apparatus and is connected to each multifunction peripheral 3 by wire or wireless so as to exchange information therewith. The edge server 4 collects IoT information sent from an IoT device 2 installed in the area 1 directly or via the multifunction peripheral 3. The information collected by the edge server 4 is transmitted to the analysis apparatus 6 via the network 5 and is used for various analyses to be executed by the analysis apparatus 6.

Installation positions of the multifunction peripherals 3 are known and the edge server 4 grasps the installation position of each multifunction peripheral 3 based on information indicating the installation position of each multifunction peripheral 3, such as information on an installation floor in a building or latitude/longitude information. The edge server 4 may grasp the installation position of each IoT device 2 in advance. Even if the installation position is not grasped, it may be estimated that an IoT device 2 communicable with a certain multifunction peripheral 3 is installed near the multifunction peripheral 3 (within a communicable range). When an IoT device 2 is communicable with a plurality of multifunction peripherals 3, it may be estimated that the IoT device 2 is installed near a middle point among the plurality of multifunction peripherals 3. The edge server 4 grasps in advance the type of each IoT device 2 installed in the area 1. Even if the type is not grasped, the edge server 4 may estimate the type of the IoT device 2 based on a device name included in the device identification information of the IoT device 2 described later or based on the contents of IoT information (type of data).

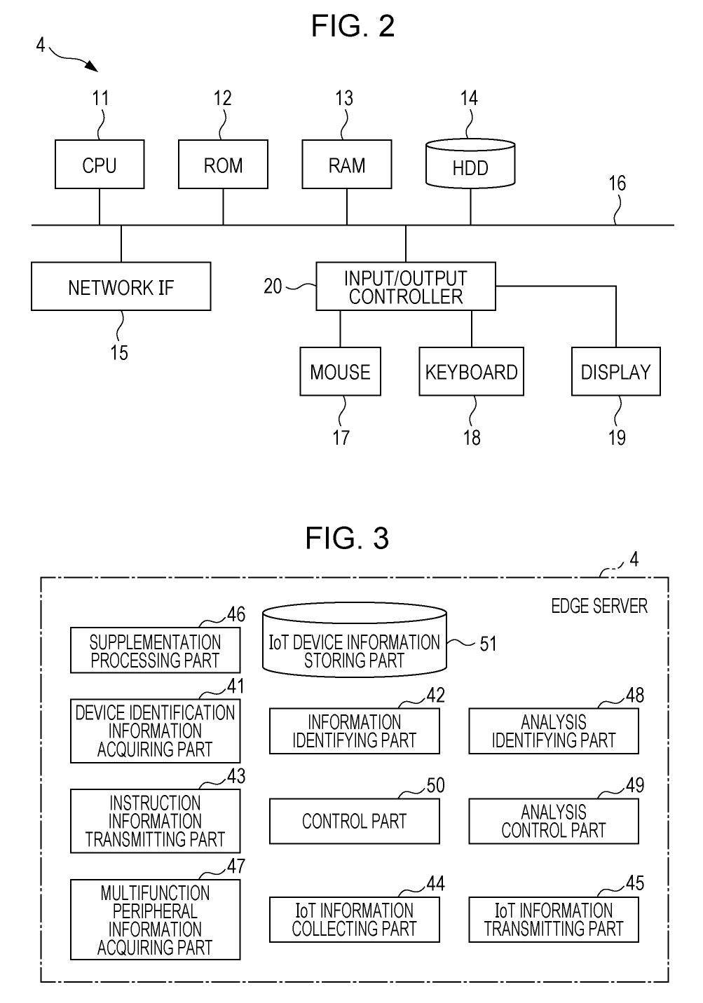

FIG. 2 is a hardware configuration diagram of the server computer serving as the edge server 4 of this exemplary embodiment. In this exemplary embodiment, the server computer serving as the edge server 4 may be implemented by an existing general-purpose hardware configuration. That is, as illustrated in FIG. 2, the computer is configurated by connecting, to an internal bus 16, a CPU 11, a ROM 12, a RAM 13, a hard disk drive (HDD) 14, and a network interface (IF) 15 provided as a communication unit. An input/output controller 20 that connects a mouse 17 and a keyboard 18 serving as an input unit and a display 19 serving as a display unit may be provided as necessary.

The multifunction peripheral 3 includes a CPU serving as the information processing apparatus, a ROM, a RAM, an HDD serving as a storage unit, an operation panel serving as a user interface, and a network interface. The multifunction peripheral 3 further includes a scanner and a printer engine in order to exert the image forming function.

When the multifunction peripheral 3 of this exemplary embodiment is activated, the multifunction peripheral 3 searches for a communicable IoT device 2. The multifunction peripheral 3 has a function of transmitting, when one or a plurality of communicable IoT devices 2 are detected, a list of pieces of device identification information indicating the detected IoT devices 2 to the edge server 4. The multifunction peripheral 3 may periodically search for a communicable IoT device 2 and detect an IoT device 2 that is turned ON after activation of the multifunction peripheral 3 to come into a state in which the IoT device 2 may send out information. The device identification information is information for distinguishing an IoT device 2 from other IoT devices 2. For example, the device identification information may be a device name, a MAC address, or an IP address assigned so as to identify each IoT device 2 in the system.

FIG. 3 is a block configuration diagram of the edge server 4 of this exemplary embodiment. The edge server 4 includes a device identification information acquiring part 41, an information identifying part 42, an instruction information transmitting part 43, an IoT information collecting part 44, an IoT information transmitting part 45, a supplementation processing part 46, a multifunction peripheral information acquiring part 47, an analysis identifying part 48, an analysis control part 49, a control part 50, and an IoT device information storing part 51. Components that are not used in the description of this exemplary embodiment are omitted from FIG. 3.

The device identification information acquiring part 41 acquires pieces of device identification information transmitted from a multifunction peripheral 3. The information identifying part 42 identifies information necessary for an analysis to be executed by the analysis apparatus 6 based on the acquired pieces of device identification information. That is, the multifunction peripheral 3 may collect pieces of IoT information sent from detected IoT devices 2 and the information identifying part 42 identifies IoT information to be collected by the multifunction peripheral 3 among the pieces of IoT information that may be collected by the multifunction peripheral 3. The instruction information transmitting part 43 collects the IoT information identified by the information identifying part 42 among the pieces of IoT information sent from the IoT devices 2 detected by the multifunction peripheral 3 and transmits, to the multifunction peripheral 3, an instruction not to collect the pieces of IoT information other than the identified IoT information. The multifunction peripheral 3 collects the IoT information specified by the instruction from the edge server 4 among the pieces of IoT information sent from the detected IoT devices 2 and the IoT information collecting part 44 collects the IoT information collected by the multifunction peripheral 3. The IoT information transmitting part 45 transmits, to the analysis apparatus 6, the IoT information collected by the IoT information collecting part 44 and IoT information collected directly by the edge server 4. The edge server 4 of this exemplary embodiment acquires, as device information, at least one of the IoT information, the device identification information described above, and information for identifying the type of the IoT information.

When the IoT information necessary for the analysis to be executed by the analysis apparatus 6 has not been collected, the supplementation processing part 46 executes processing of supplementing the IoT information that has not been collected. Details of the supplementation processing are described later. The multifunction peripheral information acquiring part 47 acquires information related to the multifunction peripheral 3 from the multifunction peripheral 3. The information related to the multifunction peripheral 3 is information related to the status of a load on the multifunction peripheral 3. Examples of this information include the number of pieces of IoT information to be collected by the multifunction peripheral 3, a load on the image forming processing to be originally executed by the multifunction peripheral 3, and information on the performance of the multifunction peripheral 3.

There are two conceivable cases regarding the analysis to be executed by the analysis apparatus 6. In the first case, the analysis is determined in advance. In the second case, an executable analysis is identified based on IoT information collected by the edge server 4. In the second case, the analysis identifying part 48 identifies an analysis executable by the analysis apparatus 6 by using the IoT information collected by the edge server 4. That is, the analysis identifying part 48 may propose an executable analysis based on the collected IoT information. The analysis control part 49 controls the analysis apparatus 6 to execute the analysis identified by the analysis identifying part 48. The control part 50 controls the operations of the other components 41 to 49.

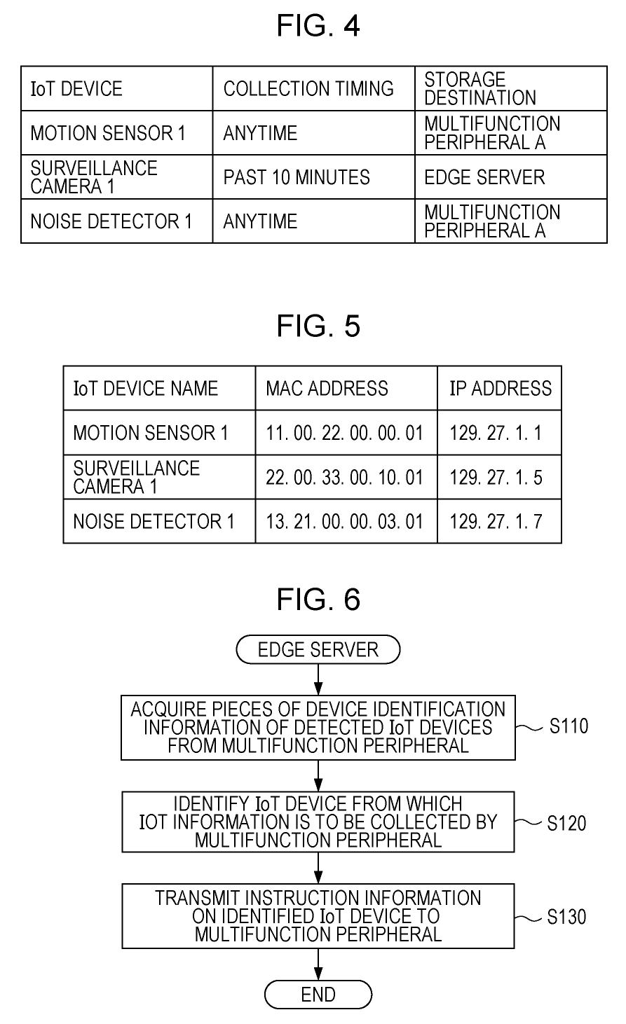

In the IoT device information storing part 51, information related to an IoT device from which IoT information is to be collected is set and registered by executing processing described later. FIG. 4 illustrates an example of the data structure of IoT device information set and registered in the IoT device information storing part 51. As illustrated in FIG. 4, the IoT device information is set by associating a “collection timing” and a “storage destination” with an “IoT device”. The “IoT device” is device identification information for identifying an IoT device 2 from which IoT information is to be collected (in FIG. 4, a device name). The “collection timing” indicates a timing to collect IoT information. For example, when the IoT device is a sensor or a detector, the IoT information is collected at the time of sensing (detecting a target object). The “storage destination” is information indicating an apparatus in which IoT information is to be stored, in other words, information indicating an apparatus that directly collects IoT information from an IoT device 2 (in the case of this exemplary embodiment, the multifunction peripheral 3 or the edge server 4). Pieces of IoT information are finally transmitted to the analysis apparatus 6 after being compiled in the edge server 4. The setting example illustrated in FIG. 4 demonstrates a case in which the edge server 4 collects IoT information via the multifunction peripheral 3 and a case in which the edge server 4 collects IoT information directly.

The components 41 to 50 of the edge server 4 are implemented by cooperative operations of the computer serving as the edge server 4 and programs to be operated by the CPU 11 mounted on the computer. The IoT device information storing part 51 is implemented by the HDD 14 mounted on the edge server 4. Alternatively, the RAM 13 may be used or an external storage unit may be used via a network.

The programs to be used in this exemplary embodiment may be provided not only by communication means but also by being stored in a computer readable recording medium such as a CD-ROM or a USB memory. The programs provided by the communication means or from the recording medium are installed in the computer and the CPU of the computer sequentially executes the programs to implement various types of processing.

The edge server 4 of this exemplary embodiment directly collects or causes the distributed multifunction peripherals 3 to collect pieces of IoT information sent from the IoT devices 2 installed in the same area 1 and transmits the pieces of IoT information to the analysis apparatus 6 for analyses. Description is made of an operation to be executed at this time by the network system of this exemplary embodiment.

When a multifunction peripheral 3 is turned ON and activated, the multifunction peripheral 3 searches for communicable IoT devices 2. The multifunction peripheral 3 detects communicable IoT devices 2 by confirming whether the multifunction peripheral 3 may execute data communication with the IoT devices 2. Then, the multifunction peripheral 3 transmits pieces of device identification information of the detected IoT devices 2 to the edge server 4. FIG. 5 illustrates an example of the data structure of the device identification information to be transmitted from the multifunction peripheral 3 to the edge server 4. The device identification information illustrated in FIG. 5 includes an IoT device name of a detected IoT device 2 and a MAC address and an IP address that are necessary for data communication with the IoT device 2. The IoT device name, the MAC address, and the IP address are acquired by the multifunction peripheral 3 by using a known method. For example, FIG. 5 illustrates pieces of device identification information to be transmitted from a multifunction peripheral A to the edge server 4. FIG. 5 illustrates an example of a case in which the multifunction peripheral A has detected three IoT devices 2 that are a motion sensor 1, a surveillance camera 1, and a noise detector 1. Processing to be executed by the edge server 4 when the pieces of device identification information are transmitted from the multifunction peripheral 3 is described below with reference to a flowchart of FIG. 6.

The edge server 4 constantly waits for transmission of device identification information from the multifunction peripheral 3. When pieces of device identification information are transmitted from the multifunction peripheral 3, the device identification information acquiring part 41 acquires the pieces of device identification information (Step 110). Then, the information identifying part 42 identifies, in the following manner, an IoT device 2 from which IoT information is to be collected by the multifunction peripheral 3 among IoT devices 2 indicated by the acquired pieces of device identification information (Step 120). The IoT device 2 and the IoT information have a one-to-one relationship and therefore the identification of the IoT device 2 is equivalent to identification of the IoT information to be collected.

Basically, the multifunction peripheral 3 may collect the IoT information sent from the IoT device 2 detected by the multifunction peripheral 3. However, the data amount of the IoT information to be sent out differs greatly depending on the IoT device 2.

For example, when the IoT device 2 is a sensor, the IoT device 2 sends out a signal indicating an event of detection or data obtained through detection (sensor data) when something is detected. For example, a motion sensor sends out, as the IoT information, a sensor signal indicating an event of detection when a person is detected. A noise detector sends out, as the IoT information, sensor data including indication of an event of detection, a volume, and the like when noise is detected. That is, the sensor or the like sends out the IoT information when an event occurs. Therefore, the data amount of the IoT information may be relatively small. When the IoT device 2 is a surveillance camera, the surveillance camera constantly captures an image of a predetermined range and sends out imaging data as the IoT information. That is, the surveillance camera constantly sends out the IoT information. Therefore, the data amount of the IoT information may be relatively large. When a large amount of data (IoT information) is stored in the multifunction peripheral 3 and then transmitted to the edge server 4, the storage area of the multifunction peripheral 3 may be cluttered with the data and the image forming processing to be originally executed by the multifunction peripheral 3 may be affected adversely.

A storage device having a relatively large capacity (HDD 14) compared with that of the multifunction peripheral 3 may be mounted on the edge server 4. In this exemplary embodiment, IoT information having a large data amount is collected directly from the IoT device 2 by the edge server 4.

For example, a threshold is set in advance for the data amount of IoT information and the information identifying part 42 of the edge server 4 assigns the multifunction peripheral 3 to collect IoT information whose data amount is equal to or smaller than the threshold and assigns the edge server 4 to directly collect IoT information whose data amount is larger than the threshold. Thus, when the list of pieces of device identification information exemplified in FIG. 5 is acquired from the multifunction peripheral A, the information identifying part 42 identifies storage destinations (collection destinations) of IoT information so that, as illustrated in FIG. 4, the multifunction peripheral A collects IoT information whose data amount is equal to or smaller than the threshold from each of the motion sensor 1 and the noise detector 1 and the edge server 4 directly collects IoT information whose data amount is larger than the threshold from the surveillance camera 1 in consideration of a load on the multifunction peripheral A. Further, characteristics of the respective types of IoT device 2 are set in advance in the edge server 4 and the information identifying part 42 sets collection timings based on the characteristics. For example, the sensor generates and sends out IoT information at the time of detecting a target object as described above and it is therefore appropriate to collect the IoT information at the timing when the IoT information is sent out. The surveillance camera constantly captures an image of a predetermined image capture range and therefore IoT information may be collected constantly. Alternatively, settings may be made so that the IoT information is collected at intervals of 10 minutes as in the setting example illustrated in FIG. 4. When the information identifying part 42 determines the collection timing and the storage destination for each IoT device 2 detected by the multifunction peripheral as described above, the information identifying part 42 sets and registers the determined items in the IoT device information storing part 51.

When the information identifying part 42 determines the collection destinations of IoT information for the IoT devices 2 detected by the multifunction peripheral A, the instruction information transmitting part 43 generates and transmits, to the multifunction peripheral A, instruction information including the determined items, that is, an instruction to collect IoT information from each of the motion sensor 1 and the noise detector 1 among the IoT devices 2 detected by the multifunction peripheral A but not to collect IoT information from the other IoT device 2, that is, the surveillance camera 1, and also including the collection timings (Step 130).

When each of the motion sensor 1 and the noise detector 1 sends out IoT information, the multifunction peripheral A collects the IoT information in accordance with the instruction from the edge server 4. Every time the IoT information is collected, the multifunction peripheral A stores the IoT information inside and transmits the IoT information to the edge server 4. Even if IoT information from the surveillance camera 1 may be collected, the multifunction peripheral A does not collect the IoT information. The IoT information stored inside the multifunction peripheral A may be deleted at any timing.

Based on the settings of the IoT device information illustrated in FIG. 4, the IoT information collecting part 44 of the edge server 4 collects the IoT information corresponding to each of the motion sensor 1 and the noise detector 1 from the multifunction peripheral A and directly collects the IoT information from the surveillance camera 1.

Although the above description has been made taking the multifunction peripheral A as an example, the edge server 4 executes similar processing for the other multifunction peripherals 3. The IoT information transmitting part 45 transmits the pieces of IoT information collected from the multifunction peripherals 3 and the pieces of IoT information collected directly by the edge server 4 to the analysis apparatus 6 at a predetermined timing. The edge server 4 may accumulate, inside the edge server 4, the pieces of IoT information collected from the multifunction peripherals 3 or directly by the edge server 4 or may delete the pieces of IoT information at any timing after the transmission to the analysis apparatus 6.

As described above, the multifunction peripheral 3 transmits the pieces of device identification information of the detected IoT devices 2 to the edge server 4, thereby notifying the edge server 4 of the IoT devices 2 from which IoT information may be collected. The information identifying part 42 of the edge server 4 determines from which of the detected IoT devices 2 the IoT information is collected by the multifunction peripheral 3 and from which of the detected IoT devices 2 the IoT information is collected directly by the edge server 4. Depending on the positional relationships between the IoT devices 2 and the multifunction peripherals 3, however, a single IoT device 2 may be detected by a plurality of multifunction peripherals 3. Thus, the edge server 4 may collect the same IoT information from the plurality of multifunction peripherals 3. In this case, the IoT information is collected inefficiently and the loads on the multifunction peripherals 3 are not reduced. In view of this, when device identification information of the same IoT device 2 is acquired from a plurality of multifunction peripherals 3, the information identifying part 42 identifies a multifunction peripheral 3 serving as an acquisition destination of IoT information in accordance with a predetermined selection criterion. For example, the predetermined selection criterion specifies a multifunction peripheral 3 that has acquired device identification information first. The information identifying part 42 registers, in the IoT device information storing part 51, an IoT device 2 from which IoT information is to be collected and therefore the multifunction peripheral 3 that has acquired device identification information first may be identified by confirming whether the IoT device 2 is not registered in the IoT device information storing part 51. As another example of the predetermined selection criterion, the number of multifunction peripherals 3 set as storage destinations in the IoT device information storing part 51 is summarized for each multifunction peripheral 3 and a multifunction peripheral 3 that has acquired fewer pieces of IoT information is caused to collect IoT information. For example, it is assumed that device identification information of the motion sensor 1 is transmitted to the edge server 4 as device identification information of an IoT device 2 detected by a multifunction peripheral B. As exemplified in FIG. 4, the motion sensor 1 has already been registered in the IoT device information storing part 51 as an IoT device 2 from which IoT information is to be collected by the multifunction peripheral A. In this case, the information identifying part 42 identifies a collection destination of the IoT information (multifunction peripheral B or edge server 4) based on the device identification information transmitted from the multifunction peripheral B. Further, the information identifying part 42 summarizes the number of IoT devices 2 from which IoT information is to be collected by the multifunction peripheral A (that is, summarizes the number of pieces of IoT information). Then, the numbers of pieces of IoT information that are handled by the multifunction peripheral A and the multifunction peripheral B are compared with each other for a case in which the multifunction peripheral A continues to collect the IoT information from the motion sensor 1 and for a case in which the multifunction peripheral A is changed to the multifunction peripheral B. As a result, the information identifying part 42 determines that a multifunction peripheral that has acquired fewer pieces of IoT information is caused to collect the IoT information from the motion sensor 1. When the acquisition destination of the IoT information from the motion sensor 1 is changed to the multifunction peripheral B, the instruction information transmitting part 43 instructs the multifunction peripheral A not to collect the IoT information from the motion sensor 1.

Thus, in this exemplary embodiment, adjustment is made so as to prevent an imbalance between the loads on the multifunction peripherals 3 in terms of collection of IoT information.

The multifunction peripheral 3 originally executes the image forming processing. As an example of the predetermined selection criterion, a multifunction peripheral 3 having a smaller load of the image forming processing on the multifunction peripheral 3 is caused to collect IoT information. For example, one or a plurality of index values that are acquired by the multifunction peripheral information acquiring part 47 and indicate the loads on the multifunction peripherals 3 are regarded as the loads on the multifunction peripherals 3 that are based on execution of the image forming processing. The index values of the multifunction peripherals 3 are compared with each other and a multifunction peripheral 3 having a smaller load of the image forming processing is determined as an acquisition destination (collection destination) of IoT information. Examples of the index value indicating the load include the number of registered jobs before execution, CPU usage, memory usage, and a communication load factor. Alternatively, the multifunction peripheral 3 serving as the collection destination of IoT information may be selected based on the number of functions provided in the multifunction peripheral 3. Further, time periods may be taken into consideration. For example, in the daytime when the load is relatively large, a multifunction peripheral 3 may be selected in accordance with the selection criterion as described above but, in the nighttime when the load is relatively small, the same IoT information may be collected from a plurality of multifunction peripherals 3 without executing the processing of selecting a multifunction peripheral 3 as described above.

In the above description, the pieces of IoT information are acquired from all the detected IoT devices 2 based on the pieces of device identification information from the multifunction peripheral 3. As described above, there are two conceivable cases regarding the analysis to be executed by the analysis apparatus 6. In the first case, the analysis is determined in advance. In the second case, an executable analysis is identified based on IoT information collected by the edge server 4. In the second case, pieces of IoT information may be acquired from all the detected IoT devices 2. In the first case, however, it is useless to collect IoT information that is not used for the analysis determined in advance. Thus, when the analysis apparatus 6 executes the analysis determined in advance, the edge server 4 causes the analysis apparatus 6 to notify the edge server 4 of the type of IoT information to be used for the analysis and the information identifying part 42 sets IoT device information so as not to collect IoT information that is not used for the analysis. Specifically, when a notification of device identification information of a detected IoT device 2 is sent from the multifunction peripheral 3 but IoT information is not used for the analysis, the IoT information is not collected. That is, the instruction information transmitting part 43 generates and transmits instruction information indicating that the IoT information that is not used for the analysis is not collected.

The analysis to be executed by the analysis apparatus 6 may be changed. That is, the IoT information to be used for the analysis may be changed. In this case, the IoT information that has not been collected in accordance with the instruction transmitted to the multifunction peripheral 3 may become necessary. In this exemplary embodiment, the supplementation processing part 46 is provided so as to supplement the IoT information that has not been collected.

That is, when the IoT information to be used for the analysis has not been collected, the supplementation processing part 46 instructs each multifunction peripheral 3 to transmit pieces of device identification information of detected IoT devices 2. In accordance with the instruction, the multifunction peripheral 3 transmits the pieces of device identification information of the detected IoT devices 2 to the edge server 4 irrespective of whether IoT information is collected.

When the device identification information acquiring part 41 acquires the pieces of device identification information transmitted from each multifunction peripheral 3 in accordance with the instruction from the supplementation processing part 46, the information identifying part 42 searches for an IoT device 2 that sends out IoT information that is necessary for the analysis but is not collected currently. Then, the information identifying part 42 identifies the IoT device 2 found through the search as an acquisition source of the IoT information that is not collected currently. When a plurality of multifunction peripherals 3 correspond to the IoT device 2, it is appropriate to select one multifunction peripheral 3 in accordance with the predetermined selection criterion described above. Then, the instruction information transmitting part 43 instructs the selected multifunction peripheral 3 to collect the IoT information. When the pieces of device identification information are acquired from each multifunction peripheral 3, the supplementation processing part 46 may review and update the IoT device information set and registered in the IoT device information storing part 51.

For some reason such as a case in which the number of IoT devices 2 or multifunction peripherals 3 is tremendous and the load of the processing of identifying the acquisition source or the acquisition destination of the IoT information is large, the supplementation processing part 46 may execute processing of generating IoT information serving as a substitute for the IoT information that is necessary for the analysis but has not been collected based on existing IoT information that has already been collected (collected IoT information) without newly starting to collect the IoT information that has not been collected. For example, when IoT information (temperature) that has not been collected is newly desired for use in the analysis, the supplementation processing part 46 generates IoT information serving as a substitute for the IoT information that has not been collected by calculating an average of temperatures collected by a plurality of IoT devices 2 (temperature sensors) located around an IoT device 2 (temperature sensor) corresponding to the IoT information that has not been collected.

As described above, in this exemplary embodiment, IoT information that has become necessary may be supplemented.

In this exemplary embodiment, the edge server 4 installed in the area 1 is used as the information collecting apparatus but the information collecting apparatus need not be implemented by the edge server 4. For example, the information collecting apparatus may be implemented by a computer such as a general-purpose PC.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information collecting apparatus, comprising:
an acquiring unit that acquires, from an information processing apparatus, pieces of device information indicating pieces of information acquirable by the information processing apparatus from network devices;
an information identifying unit that identifies information necessary for an analysis to be executed by an analysis unit among the pieces of device information; and
a transmitting unit that transmits, to the information processing apparatus, an instruction to collect the information identified by the information identifying unit among the pieces of information acquirable by the information processing apparatus from the network devices but not to collect information other than the identified information.

2. The information collecting apparatus according to claim 1, further comprising an analysis identifying unit that identifies an analysis executable by the analysis unit among a plurality of analyses by using the pieces of information acquirable by the information processing apparatus.

3. The information collecting apparatus according to claim 2, further comprising a controller that controls the analysis unit to execute the analysis identified by the analysis identifying unit.

4. The information collecting apparatus according to claim 1, further comprising a supplementation processing unit that executes processing of supplementing the information necessary for the analysis to be executed by the analysis unit when the necessary information is not included in the pieces of device information.

5. The information collecting apparatus according to claim 4, wherein the supplementation processing unit generates information serving as a substitute for the information necessary for the analysis based on the information collected by the information processing apparatus.

6. The information collecting apparatus according to claim 1, wherein, when device information of the same network device is acquired from a plurality of the information processing apparatuses, the information identifying unit identifies, in accordance with a predetermined selection criterion, one of the information processing apparatuses that serves as an acquisition destination of information to be sent from the same network device.

7. The information collecting apparatus according to claim 6, wherein the predetermined selection criterion specifies one of the information processing apparatuses that has acquired the device information of the same network device first.

8. The information collecting apparatus according to claim 6, wherein the predetermined selection criterion specifies one of the information processing apparatuses that has acquired fewer pieces of information.

9. The information collecting apparatus according to claim 6,
wherein the information processing apparatuses are image forming apparatuses, and
wherein the information identifying unit identifies, in accordance with the predetermined selection criterion, one of the image forming apparatuses that has a smaller load of image forming processing as the acquisition destination of information.

10. The information collecting apparatus according to claim 1,
wherein the network devices are IoT devices, and
wherein the information processing apparatus is an image forming apparatus.

11. A non-transitory computer readable medium storing a program causing a computer to execute a process, the process comprising:
acquiring, from an information processing apparatus, pieces of device information indicating pieces of information acquirable by the information processing apparatus from network devices;
identifying information necessary for an analysis to be executed by an analysis unit among the pieces of device information; and
transmitting, to the information processing apparatus, an instruction to collect the identified information among the pieces of information acquirable by the information processing apparatus from the network devices but not to collect information other than the identified information.

12. An information collecting apparatus, comprising:
acquiring means for acquiring, from an information processing apparatus, pieces of device information indicating pieces of information acquirable by the information processing apparatus from network devices;
information identifying means for identifying information necessary for an analysis to be executed by analysis means among the pieces of device information; and
transmitting means for transmitting, to the information processing apparatus, an instruction to collect the information identified by the information identifying means among the pieces of information acquirable by the information processing apparatus from the network devices but not to collect information other than the identified information.
